(19) United States
(12) Patent Application Publication
(10) Pub. No.: US 2015/0364223 A1
(43) Pub. Date: Dec. 17, 2015

(54) SYSTEM FOR THE IN-LINE CHARACTERIZATION OF PRODUCTS OF CORROSION

(71) Applicant: AREVA, COURBEVOIE (FR)

(72) Inventor: Karsten NOWOTKA, LE CREUSOT (FR)

(21) Appl. No.: 14/761,776

(22) PCT Filed: Jan. 17, 2014
(86) PCT No.: PCT/EP2014/050904

§ 371 Date: Jul. 17, 2015

(30) Foreign Application Priority Data
Jan. 18, 2013 (FR) 1350433

(51) Int. Cl. G21C 17/022; G21C 19/307

(52) U.S. Cl. CPC G21C 17/022; G21C 19/307

(57) ABSTRACT

A system for characterizing products of corrosion which are present in a nuclear reactor cooling circuit, the characterization system having a pipe connected to the reactor cooling circuit through which the coolant flows, the system including at least two filters in series, the downstream filter having a smaller pore size than the filter situated upstream, the filters being able to have the cooling fluid passed through; differential-pressure sensors associated with each of the filters make it possible to determine the extent to which each of the filters is obstructed; a temperature-regulating system to regulate the temperature of the liquid flowing through the pipe.

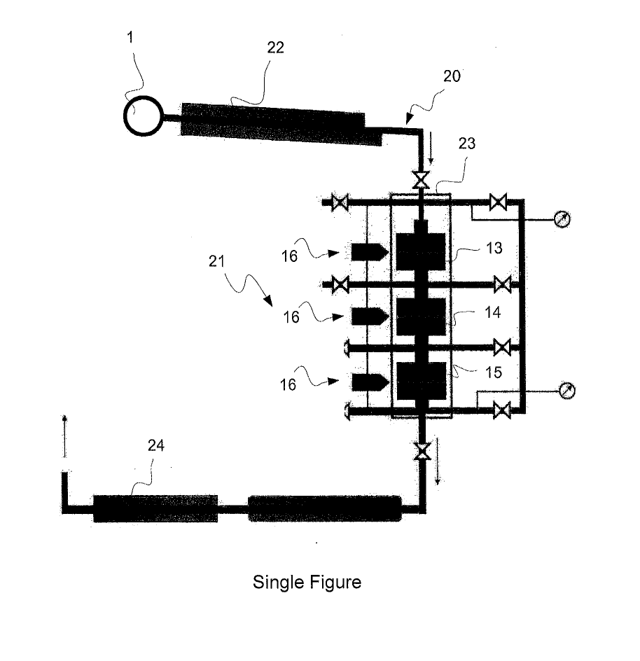

### TECHNICAL FIELD

The field of the invention is that of in-line characterization of corrosion products being formed in the primary and secondary circuit of a nuclear reactor.

### STATE OF THE ART

In the primary and/or secondary circuit of a nuclear reactor, a certain corrosion of the circuit occurs which causes the formation of corrosion products which are partly soluble in the primary and/or secondary water of the circuit. These colloids of corrosion products have a water solubility which decreases when the water temperature increases.

Thus, during the operation of the nuclear reactor, the water of the primary circuit which has a high temperature becomes loaded with solid insoluble corrosion products, resulting in a contamination and possibly a degradation of some parts of the primary circuit because of the formation of solid deposits.

In the secondary circuit, colloids of the corrosion products take part in the phenomenon of deposit formation in the steam generators, thus leading to a fall in the efficiency of the power plant and possibly to a degradation of the secondary circuit.

Consequently it is necessary to be able to control, during the operation of the reactor, the solid insoluble corrosion product content in the primary and/or secondary circuit of the reactor.

It is known from document EP 0077258 (D1) a method and a system aiming at determining the concentration of solid insoluble corrosion products present in a liquid at high temperature and pressure, so as to approach the design operating conditions of a nuclear reactor.

However, the system described in document D1 does not enable the quantity of corrosion products present in the liquid flowing in the cooling circuit to be accurately characterized, since the analysis step takes place after a decrease in temperature and pressure of the sample taken in the cooling circuit.

Consequently, such a device is not representative of the corrosion products in the primary and/or secondary circuit under the actual operating conditions of the reactor.

### DISCLOSURE OF THE INVENTION

In this context, the invention aims at providing a system for characterizing corrosion products enabling corrosion products present in a primary and/or secondary circuit to be characterized as close as possible to the operating conditions.

To this end, the invention provides a system for characterizing corrosion products present in a nuclear reactor cooling circuit, said characterizing system having a pipe connected to the cooling circuit of the reactor through which the cooling fluid flows, the system being characterized in that it includes:
at least two filtration means in series, the downstream filtration means having a smaller pore size than the filtration means situated upstream, the filtration means being able to have the cooling fluid passed through;
differential-pressure sensors associated with each of the filtration means making it possible to determine the obstruction rate of each of the filtering means;
a temperature-regulating means regulating the temperature of said cooling fluid flowing in the pipe.

Thanks to the device according to the invention, the corrosion products can be characterized under temperature conditions close to the design operating conditions of the reactor.

The characterizing system according to the invention thus enables the nature of the particles as well as the quantity of corrosion products in the nuclear reactor cooling circuits (primary circuit and secondary circuit) to be identified.

Such a device thus enables a better representability of the solid corrosion products present in the primary and/or secondary circuit to be obtained during an operation of the nuclear reactor.

Such a device also enables a law to be established on the physico-chemical behaviour of the corrosion products as a function of the liquid temperature, the regulating means enabling the liquid temperature to be increased or reduced.

Furthermore, such a characterizing system of the invention would also enable the volume and surface activities of radionuclides of the plant unit to be better understood, an inventory of the corrosion products of the plant unit to be drawn up and membranes and purification filters adapted to the needs of the market to be developed.

The characterizing system according to the invention can also have one or more of the characteristics hereinbelow taken individually or according to any technically possible combinations:
the system includes three filtration means in series having different filtering characteristics;
a first filtration means has pores the size of which is between 3 μm and 5 μm;
a second filtration means has pores the size of which is between 0.4 μm and 0.6 μm;
a third filtration means has pores the size of which is between 0.01 μm and 0.1 μm;
the differential-pressure sensors associated with each of the filtration means make it possible to determine in-line the obstruction rate of each of the filtering means;
the temperature-regulating means is formed by a first heating and/or cooling means for regulating the temperature of the cooling fluid passing through said at least two filtration means in series and/or by a second heating and/or cooling means for regulating the temperature of the cooling fluid flowing upstream of the filtration means;
the temperature-regulating means regulates the temperature of the liquid between 200° C. and 360° C.;
the system includes means for maintaining the pressure between 60 and 150 bars at the filtration means.

### BRIEF DESCRIPTION OF THE FIGURE

Further characteristics and advantages of the invention will appear more clearly from the description thereof given hereinbelow, by way of indicating and in no way limiting purposes, with reference to the single FIGURE schematically illustrating a characterizing system according to the invention.

### DETAILED DESCRIPTION OF AT LEAST ONE EMBODIMENT

The single FIGURE illustrates a schematic view of the system for in-line characterizing corrosion products present in a cooling circuit of a nuclear reactor according to the invention.

The characterizing system 100 according to the invention is an apparatus enabling an in-series filtration to be made, advantageously in-line (i.e. continuous during the operation of the reactor) under conditions similar to the design operating conditions of the nuclear reactor.

The system 100 includes a pipe 20 connected through a tap to the cooling circuit 1 of the reactor (primary or secondary circuit) so as to allow a permanent flow of the cooling fluid in the pipe 20, in the direction indicated by the arrows.

The cooling fluid passes through a filtration apparatus 21 comprised of three filtration membranes respectively referenced 13, 14 and 15 in the flow direction of the liquid in the pipe 10. Each of the membranes 13, 14, 15 has a different pore size, the downstream positioned membrane having a smaller pore size than the upstream positioned membrane. Thus, the filtration apparatus enables the size distribution of the corrosion products to be characterized in the form of colloids (i.e. between 1 nm (nanometre) and 1 μm (micrometre)). Advantageously, the first filtering membrane 13 has pores the size of which is between 3 μm and 5 μm.

Advantageously, the second filtering membrane 14, situated downstream of the first membrane 13, has pores the size of which is between 0.4 μm and 0.6 μm.

Advantageously, the third filtering membrane 15, situated downstream of the second membrane 14, has pores the size of which is between 0.01 μm and 0.1 μm.

When the cooling fluid flows in the pipe 20, different membranes 13, 14, and 15 clog depending on the quantity and nature of the corrosion products present in the cooling fluid. The clogging of each of the membranes 13, 14, 15 is followed in-line by an operator by differential-pressure sensors 16 measuring the pressure difference of the fluid between upstream and downstream of each of the membranes 13, 14, 15. From the measurements performed by the differential-pressure sensors 16, the nature and concentrations of the corrosion products can be assessed by comparison with standards.

The pipe 20 also includes a temperature-regulating means 22, positioned upstream of the filtration apparatus 21. This temperature-regulating means 22 enables the liquid to be cooled and/or heated at a desired characterization temperature before it passes through the filtration apparatus 21.

The characterizing system 100 according to the invention is particularly intended to characterize corrosion products present in the cooling liquid under the design operating conditions. Thus, for example, the regulating means 22 enables the liquid to be regulated at a temperature between 200° C. and 360° C.

So as to further improve the system and guarantee the performance of a characterization in corrosion products at a given temperature, the filtration apparatus 21 is surrounded by second temperature-regulating means 23 enabling the temperature of the liquid to be maintained at the desired temperature upon passing through the membranes 13, 14, 15.

Advantageously, the temperature-regulating means 23 are formed by an oven enabling the liquid flowing through the membranes to be maintained between 200° C. and 360° C.

By way of example, the pipe 20 of the characterizing system 100 according to the invention can be used to characterize the corrosion products in a liquid under temperature conditions ranging from 200° C. to 360° C. and pressure conditions ranging from 60 to 150 bars by a set of valves and pressure sensors.

The system 100 also includes a cooling means 4 enabling the liquid to be cooled after filtration before being collected for reprocessing.

After an in-line analysis of the corrosion products, the membranes can be dismantled and recovered for complementary analyses so as to obtain more specific information about the chemical and/or morphological nature of the colloids.

Thus, the system according to the invention enables a better representability of the corrosion products flowing in the primary and/or secondary circuit of the nuclear reactor to be obtained. Thus, results obtained thanks to the system according to the invention would enable for example evolutions of the fouling factor and/or clogging rate of a steam generator to be better comprehended.

1. A system for characterizing corrosion products which are present in a nuclear reactor cooling circuit, said characterizing system comprising:
a pipe for connection to the cooling circuit of the reactor through which the cooling fluid flows;
at least two filters arranged in series, a downstream filter of the at least two filters having a smaller pore size than a filter of the at least two filters situated upstream, the at least two filters configured to have the cooling fluid passed through;
differential-pressure sensors associated with each of the at least two filters making it possible to determine an obstruction rate of each of the at least two filters;
a temperature-regulating system configured to regulate the temperature of said cooling fluid flowing in the pipe.

2. The system for in-line characterizing corrosion products which are present in a nuclear reactor cooling circuit according to claim 1, wherein the at least two filters include three filters arranged in series having different filtering characteristics.

3. The system for in-line characterizing corrosion products present in a nuclear reactor cooling circuit according to claim 2, wherein a first of the three filters has pores the size of which is between 3 μm and 5 μm.

4. The system for in-line characterizing corrosion products which are present in a nuclear reactor cooling circuit according to claim 3, wherein a second of the three filters has pores the size of which is between 0.4 μm and 0.6 μm.

5. The system for in-line characterizing corrosion products which are present in a nuclear reactor cooling circuit according to claim 4, wherein a third of the three filters has pores the size of which is between 0.01 μm and 0.1 μm.

6. The system for in-line characterizing corrosion products which are present in a nuclear reactor cooling circuit according to claim 1, wherein the differential-pressure sensors associated with each of the at least two filters make it possible to determine in-line the obstruction rate of each of the at least two filters.

7. The system for in-line characterizing corrosion products which are present in a nuclear reactor cooling circuit according to claim 1, wherein the temperature-regulating system is formed by a first heating and/or cooling component for regulating the temperature of the cooling fluid passing through said at least two filters arranged in series and/or by a second heating and/or cooling component for regulating the temperature of the cooling fluid flowing upstream of the at least two filters.

8. The system for in-line characterizing corrosion products which are present in a nuclear reactor cooling circuit according to claim 1, wherein the temperature-regulating system is configured to regulate the temperature of the cooling fluid between 200° C. and 360° C.

9. The system for in-line characterizing corrosion products which are present in a nuclear reactor cooling circuit according to claim 1, further comprising a pressure system for maintaining the pressure between 60 and 150 bars at the at least two filters.

10. The system for the in-line characterisation of corrosion products which are present in a nuclear reactor cooling circuit according to claim 1, wherein each of the at least two filters is formed by a membrane.
